(19) United States
(12) Patent Application Publication
(10) Pub. No.: US 2005/0251426 A1
(43) Pub. Date: Nov. 10, 2005

(54) Apparatus for making medical operating information accessible

(76) Inventors: Holger Dresel, Altendorf (DE); Rainer Kuth, Herzogenaurach (DE)

Correspondence Address: SCHIFF HARDIN LLP;Patent Department, 6600 Sears Tower, 233 South Wacker Drive, Chicago, IL, 60606, US

(21) Appl. No.: 11/123,623

(22) Filed: May 6, 2005

(30) Foreign Application Priority Data
May 6, 2004 (DE) 10 2004 022 333.5

(51) Int. Cl. G06F 17/60

(52) U.S. Cl. 705/3

(57) ABSTRACT

An apparatus for making medical operating information accessible has a central server via which a consumer can search a databank with medical operating information in order to find medical operating information suitable for the consumer purposes. The consumers likewise can offer their own measurement parameters to other consumers for use. The apparatus supervises a point system allowing points to be exchanged for medical operating information. Points also can be purchased for payment and likewise converted into monetary-value benefits.

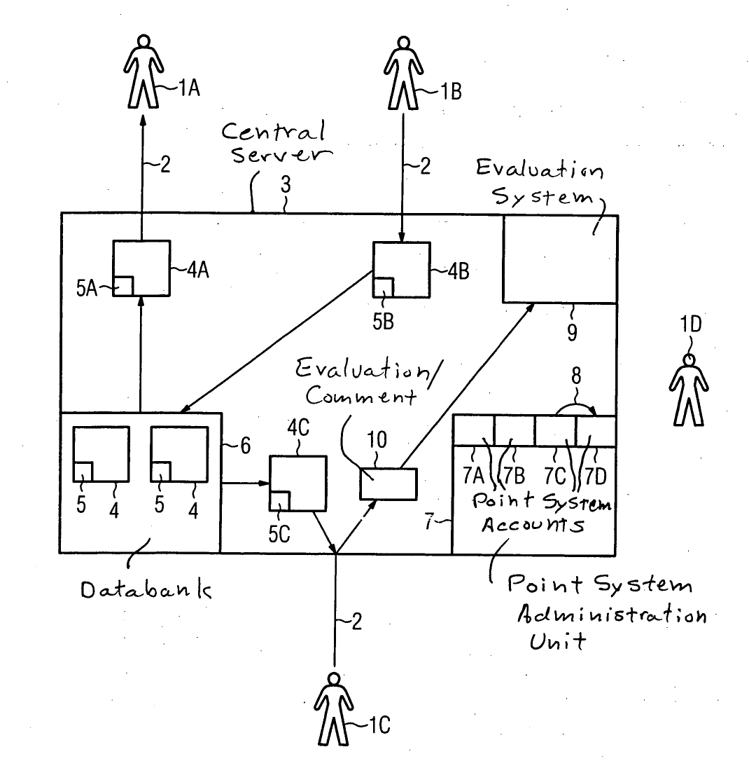

### BACKGROUND OF THE INVENTION

1. Field of the Invention

The present invention concerns an apparatus for making medical operating information accessible, of the type having a databank with medical operating information and a transfer system, with the transfer system connected with the databank and that enables users of the apparatus to retrieve medical operating information from the databank and/or add to the databank.

2. Description of the Prior Art

Input of various medical operating information by a user is frequently necessary for implementation of a measurement by means of a measurement (examination) apparatus. This information can be, for example, measurement parameters or evaluation parameters, or measurement instructions in the form of macros. The setting of a number of measurement parameters is particularly necessary in imaging diagnostics in order to ensure a sufficiently good image quality. Due to the complex interaction among the various measurement parameters, it is possible that a user may not set the optimal measurement parameters, and thereby worsens the image quality, for example when pressed for time. This in turn makes a diagnosis from an image difficult for a doctor.

An arrangement for making expertise accessible for a user (doctor) of a medical examination apparatus is known from European Application 1 306 791. Via a transfer system, the doctor can obtain an operating procedure, customized for a specific medical diagnoses, in the form of pulse sequences, protocols or parameter sets for the examination apparatus. At the same time, a coupled license billing system (from which the creator (proprietary owner) procedure receives a license fee) and a blocking device that prevents a further use beyond the stipulated and paid use. With this arrangement, it is also possible for moderately trained personnel to execute complex diagnoses with the aid of expert knowledge. A disadvantage of this procedure is the fact that, in general, an expert is not available twenty-four hours a day, such that in some circumstances no procedure is available immediately during or shortly before the examination.

A method for preparation of a magnetic resonance exposure using already-acquired exposures is known from German OS 101 18 194. In a first step, already-obtained magnetic resonance exposures are graphically shown and the associated acquisition parameters are stored. The acquisition parameters that are thus available can be transferred in a simple manner for further exposures with the method. This method offers the advantage that it significantly simplifies operation of a magnetic resonance apparatus. Due to the complex interaction of the multiple setting parameters, the simple transfer of already-used measurement parameters offers a significant time advantage and a simplification. However, in this method only measurements implemented on the same magnetic resonance apparatus can be accessed, so the “inventory” of already-implemented magnetic resonance acquisitions is limited and the complete application spectrum may not be covered.

A method for supporting networking of technical apparatuses is specified in German OS 101 37 172. A service technician can ask for and download technical operating information from a databank, for example about a magnetic resonance apparatus and an image processing apparatus. The information can be, for example, manufacturer, product names, type designation, the version and the DICOM functionality of the magnetic resonance apparatus and of the image processing apparatus. Configuration data that make the networking the magnetic resonance apparatus and of the image processing apparatus easier can additionally be retrieved from the databank. The configuration data are DICOM services, network addresses, port numbers, subnet masks, gateway addresses, server addresses and results of tests about the networking of a magnetic resonance apparatus and an image processing apparatus of the same type. After successful networking, the service technician transfers the (possibly modified) configuration data to the databank. A transfer of data necessary for the medical operation of the magnetic resonance apparatus, however, is not provided.

A preparation apparatus for the medical field is specified in German OS 198 52 792 concerning cleaning systems, drying systems, disinfection systems or sterilizers. Activation of the preparation apparatus can ensue via an external computer. Program packets stored on the preparation system can be readout by a monitoring unit, whereby a user interface is generated.

A method and an apparatus for community administration for conducting services at remote systems is known from German OS 100 65 667 that allows access to protected software applications at remote systems by a central service. A diagnosis system for a user is provided with services after authentication of the user and approval for access. These services can be configuration files or protocols. The approval ensues via a policy server that has access to a databank with user data. These can be user names, passwords, security codes, serial numbers and information about the software applications for which users are authorized for access corresponding to existing contracts. Via the described device, the user has access only to previously contractually established software applications. Given the occurrence of new medical questions, for example, real-time access to corresponding software applications is not provided.

### SUMMARY OF THE INVENTION

An object of the present invention is to provide an apparatus for making medical operating information accessible, in which a user has access, as needed, to a large quantity of medical operating information for various examination methods and can incorporate the information into the examination methods in a simple manner.

The above object is achieved in accordance with the present invention in an apparatus for making medical operating information accessible to consumers, having a databank containing medical operating information and a transfer system connected to the databank that enables consumers to retrieve the medical operating information from the databank and/or to add information to the databank, and wherein the apparatus includes a point system administration unit, connected to the transfer system, that administers/supervises a point system by maintaining a point account for each consumer. The point account contains points accumulated by the respective consumer associated therewith. Each consumer buys points that are entered into the consumer's point account, and can purchase medical operating information from the databank by transferring a predetermined number of points from the consumer's account to the account of a supplier of the medical operating information.

Because the users make medical operating information mutually accessible, a robust exchange is created between the users. Each user can act both as a provider and as a consumer. The medical operating information can be stored, for example, together with images, such that consumers who may want to use the medical operating information immediately receive a result of measurements implemented with this medical operating information. The access to the medical operating information provided by a supplier in principle can ensue at any time of day and night without that supplier actively participating in the exchange. Because each provider does not always need an image from the consumer who would like to have one from the provider, the apparatus embodies a point system. A point account is associated with each user, whose account status is increased, for example, by the purchase of points or by placement of medical operating information into the databank. Users can purchase medical operating information from providers by means of the points. A conversion into benefits in dollar value is also likewise possible. For example, stock options or cash can be used for this. This offers the users a good inducement to provide and to exchange their medical operating information to/with other users, such that it leads to a robust exchange of medical operating information via such an apparatus.

In an embodiment, the apparatus is connected with a data processing system of a user. The user can retrieve medical operating information from the databank via the transfer system. The data processing system can simultaneously be connected with a number of apparatuses in a peer-to-peer network in order to, for example, be able to access a larger data pool. The data processing system of the user can also contain a databank with medical operating information to which the other users have access.

In a embodiment the apparatus has a central server to which the user can connect via remote data transfer and which has a databank of medical operating information and correspondingly associated images. Consumers thereby have continuous access to a large quantity of medical operating information that they can purchase for use in their own measurements.

The apparatus can have an access monitor in which the user must be authenticated to the apparatus. This helps guard against misuse of the apparatus.

The apparatus further can have an evaluation system for users and medical operating information. Users can thereby submit evaluations—for example in a grading system or via short comments—after purchase or exchange of medical operating information for this and the respective participating user. This has the advantage that a consumer has information about the quality of the corresponding medical operating information before purchase or exchange of the medical operating information and receives an impression of the exchange behavior of the corresponding provider, and according to this can better make a decision to purchase or exchange the medical operating information.

A further embodiment of the apparatus allows the possibility of the provider limiting the use of the offered medical operating information. For example, medical operating information may be used by a consumer only for a limited time or a limited number of patients. After the expiration of this license, the consumer can reorder the same medical operating information from the provider or renew the license. The inducement to participate in the exchange of medical operating information is thereby additionally increased for the provider since medical operating information placed once into the system can be purchased multiple times by the same consumer.

The medical operating information is stored within an image file in an embodiment of the invention. For example, for magnetic resonance examinations the measurement parameters that are used are stored in an image header. The image data have been generated with the operating information, thus for example with a set of measurement parameters. Other users thus can directly view, as a reference, an image generated with the respective operating information and thereupon decide to exchange.

### DESCRIPTION OF THE DRAWING

The single FIGURE is a schematic block diagram of an apparatus for making medical operating information accessible, constructed and operating in accordance with the present invention.

### DESCRIPTION OF THE PREFERRED EMBODIMENTS

According to the FIGURE, various users 1A, 1B, 1C are connected with a central server 3 via remote data transmission connections 2 (for example via the Internet). They can transmit both new images 4A, 4B and medical operating information 5A, 5B to the server 3 and also retrieve from this. The operating information 5, 5A, 5B, 5C can be both measurement or evaluation parameters and macros. The images 4 and medical operating information 5 are held in a databank 6. The communication between server 3 and the users 1A, 1B, 1C occurs completely within a web browser, according to the paradigm of an online shop. After a user 1A, 1B, 1C has connected with the server 3, an authentication by means of a password input is necessary. In a point system administration unit 7, a point account 7A, 7B, 7C, 7D is associated with each user 1A, 1B, 1C, 1D. If a consumer 1C would like to purchase an image 4C of a supplier 1D and the associated medical operating information 5C, a transfer 8 of a corresponding number of points (established by the provider 1D) to his point account 7D is to be initiated. The supplier 1D does not have to be connected with the server at this point in time. The consumer 1C can simply integrate the purchased medical operating information 5C into the consumer's measurement procedure, in that the consumer 1C accepts it for a measurement via drag-and-drop. The consumer 1C can work with the measurement parameters for a limited time or a limited number of patients, in the event that the supplier 1D has provided this. The medical operating information 5C is subsequently no longer usable by the consumer 1C without purchasing it again or purchasing a new license from the supplier 1D. This increases the inducement for the suppliers 1D to provide their medical operating information 5C.

The server 3 includes an evaluation system 9 by means of which the consumer 1C can submit an evaluation or a comment 10 about the medical operating information 5C and the supplier 1D after the end of the exchange event, which evaluation or comment 10 is visible by other interested parties and thus makes a decision easier. Dependent on the evaluation, the respective supplier 1D is credited bonus points to the supplier's point account for particularly highly-evaluated medical operating information, which further increases the inducement to provide medical operating information. Moreover, the supplier 1D can submit a comment about the consumer 1C.

With particularly active suppliers who provide and exchange many sets of medical operating information in the system, many points will be available in the account after a certain time. A conversion of the points into monetary-value benefits offers an additional inducement to provide the medical operating information in the system. For example, stock options, money or a free participation in training or courses are available as monetary-value benefits.

Although modifications and changes may be suggested by those skilled in the art, it is the intention of the inventors to embody within the patent warranted hereon all changes and modifications as reasonably and properly come within the scope of their contribution to the art.

1. An apparatus for making medical operating information accessible to consumers, comprising:
a databank containing medical operating information supplied to the databank by at least one supplier;
a transfer system connected to the databank and accessible by at least one consumer to enable said at least one consumer to retrieve said medical operation information from the databank and to allow said supplier to add said medical operating information to the databank; and
a point system administration unit connected to the transfer system that maintains a point account for each consumer containing points belonging to that consumer, said point account administration unit allowing each consumer to buy points in said point system and to purchase said medical operating information by deleting points from the account of the consumer.

2. An apparatus as claimed in claim 1 wherein said transfer system is adapted for electronic interaction with a data processing unit maintained by said at least one consumer, said transfer system electronically transferring the purchased medical operating information from said databank to said data processing unit.

3. An apparatus as claimed in claim 1 comprising a server containing said databank, said server being connectable via a remote data transmission connection to a remote station accessible by said at least one consumer.

4. An apparatus as claimed in claim 1 wherein said transfer system comprises an access monitoring system that allows access to said databank by said at least one consumer only after successful completion of an access control protocol that denies access to an unauthorized consumer.

5. An apparatus as claimed in claim 1 comprising an evaluation system accessible by multiple consumers allowing each consumer to enter evaluation comments relating to medical operating information purchased by that consumer, and allowing others of said multiple consumers to retrieve said evaluation comments.

6. An apparatus as claimed in claim 1 wherein said databank stores said medical operating information with a use limitation, that limits a number of uses of said medical operating information by a consumer, associated therewith, and wherein said point system administration unit sets a number of said points required for a consumer to purchase said medical operating information dependent on said use limitation.

7. An apparatus as claimed in claim 6 wherein said use limitation limits usage of said medical operating information to one use.

8. An apparatus as claimed in claim 1 wherein said databank stores said medical operating information in an image file.
